(19) United States
(12) Patent Application Publication
(10) Pub. No.: US 2026/0327895 A1
(43) Pub. Date: Oct. 22, 2026

(54) CLOTHES TREATING APPARATUS

(71) Applicant: SAMSUNG ELECTRONICS CO., LTD., Suwon-si (KR)

(72) Inventors: Yonggyun YIM, Suwon-si (KR); Younghyun KIM, Suwon-si (KR); Jongwon PARK, Suwon-si (KR); Wonyoung SEO, Suwon-si (KR); Sooam PARK, Suwon-si (KR); Seungil LIM, Suwon-si (KR)

(21) Appl. No.: 19/468,256

(22) Filed: Feb. 3, 2026

Related U.S. Application Data
(63) Continuation of application No. PCT/KR2024/008823, filed on Jun. 26, 2024.

(30) Foreign Application Priority Data
Aug. 31, 2023 (KR) 10-2023-0115796
Jan. 3, 2024 (KR) 10-2024-0001045

(51) Int. Cl. D06F 58/22; B01D 46/00; B01D 46/42; D06F 58/04

(52) U.S. Cl. CPC D06F 58/22; B01D 46/0002; B01D 46/4227; D06F 58/04

(57) ABSTRACT

A clothes treating apparatus may include a tub, a drying device configured to supply dry air to the tub and including a drying case on which an evaporator and a condenser are mounted, a filter detachably mountable on the drying device, and a sealing member configured to seal between the filter and the drying case when the filter is mounted on the drying device. The drying case may include a filter rail configured to guide the filter so that the sealing member is spaced apart from the drying case while the filter is mounted on the drying device, and a close-contact guide configured to guide the filter so that the sealing member comes into close contact with the drying case when the filter is mounted on the drying device.

### CROSS-REFERENCE TO RELATED APPLICATIONS

This application is a continuation of International Application No. PCT/KR2024/008823 designating the United States, filed on Jun. 26, 2024, in the Korean Intellectual Property Receiving Office and claiming priority to Korean Patent Application Nos. 10-2023-0115796, filed on Aug. 31, 2023, and 10-2024-0001045, filed on Jan. 3, 2024, in the Korean Intellectual Property Office, the disclosures of each of which are all incorporated by reference herein in their entireties.

### TECHNICAL FIELD

Certain example embodiments may relate to a clothes treating apparatus including a drying device.

### BACKGROUND

A clothes treating apparatus may be an apparatus for, at least, treating and/or managing clothes. The clothes treating apparatus may include a washing machine and/or a drying device. The washing machine may, for example, include a drying combined washing machine.

A drying combined washing machine may be an apparatus that performs washing through friction between laundry, water, and a detergent put into a tub by stirring the laundry, water, and detergent together using a driving force of a driving motor.

A procedure to be performed by a drying combined washing machine may include a washing process of supplying the detergent and water to the tub accommodating laundry and washing the laundry while rotating a drum, a rinsing process of supplying water to the tub and rotating the drum to rinse the laundry, and a dewatering process of discharging the water from the tub and rotating the drum to remove moisture from the laundry.

A procedure to be performed by the drying combined washing machine may include a drying process of blowing heat generated from a drying device into an accommodation space in which the laundry is accommodated to dry the laundry. The drying combined washing machine may include the drying device to perform the drying process.

### SUMMARY

Certain example embodiments may provide a clothes treating apparatus capable of reducing damage to a sealing member sealing between a filter and a drying device.

Certain example embodiments may provide a clothes treating apparatus in which a filter may be easily mounted on a drying device.

Certain example embodiments may provide a clothes treating apparatus capable of reducing air leakage into a filter.

Certain example embodiments may provide a clothes treating apparatus in which a filter may be stably fixed to a drying device.

Certain example embodiments may provide a clothes treating apparatus having improved performance of a filter mounted on a drying device.

Technical tasks to be achieved in this document are not limited to the technical task mentioned above, and other technical tasks not mentioned will be clearly understood by those skilled in the art from the description below.

A clothes treating apparatus according to an certain example embodiments may include a tub, a drying device configured to supply dry air to the tub and including a drying case on which an evaporator and a condenser are mounted directly or indirectly, a filter detachably mountable on the drying device, and a sealing member, comprising sealing material, configured to seal between the filter and the drying case when the filter is directly or indirectly mounted on the drying device. The drying case may include a filter rail provided to guide the filter so that the sealing member is spaced apart from the drying case while the filter is directly or indirectly mounted on the drying device, and a close-contact guide provided to guide the filter so that the sealing member comes into close contact with the drying case when the filter is directly or indirectly mounted on the drying device.

A clothes treating apparatus according to an certain example embodiments may include a tub, a drying device configured to supply dry air to the tub and including a drying case on which an evaporator and a condenser are directly or indirectly mounted, a filter detachably mountable on the drying device, and a sealing member configured to seal between the filter and the drying case when the filter is directly or indirectly mounted on the drying device. The drying case may include a filter rail provided to guide the filter so that the sealing member is spaced apart from the drying case while the filter is directly or indirectly mounted on the drying device, a close-contact guide provided to press a rear end of the filter so that the sealing member comes into close contact with the drying case when the filter is directly or indirectly mounted on the drying device, and a case support portion provided to press a front end of the filter so that the sealing member comes into close contact with the drying case when the filter is directly or indirectly mounted on the drying device.

### BRIEF DESCRIPTION OF DRAWINGS

FIG. 1 illustrates a clothes treating apparatus according to certain example embodiments.

FIG. 2 illustrates a cross-section of the clothes treating apparatus according to certain example embodiments.

FIG. 3 illustrates some of components arranged inside the clothes treating apparatus according to certain example embodiments.

FIG. 4 illustrates the components arranged inside the clothes treating apparatus according to certain example embodiments from a direction different from a direction illustrated in FIG. 3.

FIG. 5 is an exploded view illustrating some components of a drying device according to certain example embodiments.

FIG. 6 is an exploded view illustrating some components of the drying device according to certain example embodiments.

FIG. 7 illustrates a drying base and a filter according to certain example embodiments from a direction different from a direction illustrated in FIG. 6.

FIG. 8 illustrates the drying base according to certain example embodiments.

FIG. 9 is an enlarged view of area A shown in FIG. 6.

FIG. 10 illustrates a portion of the drying case according to certain example embodiments.

FIG. 11 is an exploded view of the filter according to certain example embodiments.

FIG. 12 illustrates a state in which a filter cover is mounted on a filter body according to certain example embodiments.

FIG. 13 illustrates a cross-section cut along line B-B′ shown in FIG. 12.

FIG. 14 illustrates a state in which the filter according to certain example embodiments is separated from the clothes treating apparatus.

FIG. 15 illustrates a state in which the filter according to certain example embodiments is inserted into the drying case to a first position.

FIG. 16 illustrates a cross-section cut along line C-C′ shown in FIG. 15.

FIG. 17 is an enlarged view of area D shown in FIG. 16.

FIG. 18 illustrates a cross-section cut along line E-E′ shown in FIG. 15

FIG. 19 illustrates a state in which the filter according to certain example embodiments is inserted into the drying case to a second position.

FIG. 20 illustrates a cross-section cut along line F-F′ shown in FIG. 19.

FIG. 21 is an enlarged view of area G shown in FIG. 20.

FIG. 22 illustrates a state in which the filter according to certain example embodiments is inserted into the drying case to a third position.

FIG. 23 illustrates a cross-section cut along line H-H′ shown in FIG. 22

FIG. 24 is an enlarged view of area I shown in FIG. 23.

FIG. 25 illustrates a cross-section cut along line J-J′ shown in FIG. 22.

FIG. 26 is an enlarged view of area K shown in FIG. 25.

FIG. 27 illustrates a cross-section cut along line L-L′ shown in FIG. 22.

### DETAILED DESCRIPTION

Various embodiments and terms in this document are not intended to limit the technical features described in this document to specific embodiments, and should be understood to include various modifications, equivalents, or substitutes of the embodiments.

In connection with the description of the drawings, like reference numbers may be used for like or related components.

The singular form of a noun corresponding to an item may include one item or a plurality of items, unless the relevant context clearly dictates otherwise.

In this document, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms such as “first,” “second,” “primary,” and “secondary” may simply be used to distinguish a given component from other corresponding components, and do not limit the corresponding components in any other aspect (e.g., importance or order).

When any (e.g., a first) component is referred to as being “coupled” or “connected” to another (e.g., a second) component with or without the terms “functionally” or “communicatively,” this means that the any component may be connected to the other component directly (e.g., by a wire), wirelessly, or through at least a third component(s).

The terms “comprises,” “has,” and the like are intended to indicate that there are features, numbers, steps, operations, components, parts, or combinations thereof described in this document, and do not exclude the presence or addition of one or more other features, numbers, steps, operations, components, parts, or combinations thereof.

When any component is referred to as being “connected to,” “coupled to,” “supported on” or “in contact with” another component, this includes a case in which the components are indirectly connected to, coupled to, supported on, or in contact with each other through a third component as well as directly connected to, coupled to, supported on, or in contact with each other.

When any component is referred to as being located “on” or “over” another component, this includes not only a case in which any component is in contact with another component but also a case in which another component(s) is present between the two components.

A washing machine according to various embodiments may perform washing, rinsing, dewatering, and drying processes. The washing machine is an example of a clothes treating apparatus, and the clothes treating apparatus is a concept encompassing an apparatus for washing clothes (objects to be washed, objects to be dried), an apparatus for drying clothes, and an apparatus capable of washing and drying clothes.

Washing machines according to various embodiments may include a top-loading washing machine in which a laundry inlet for putting in or taking out laundry is provided to face the top or a front-loading washing machine in which a laundry inlet is provided to face the front. A washing machine according to various embodiments may include a washing machine of another loading method other than a top-loading washing machine and a front-loading washing machine.

In the case of a top-loading washing machine, laundry may be washed using a water current occurred by a rotating body such as a pulsator. In the case of a front-loading washing machine, laundry may be washed by rotating a drum to repeatedly raise and drop the laundry. A front-loading washing machine may include a drying combined washing machine capable of drying laundry accommodated inside the drum. A drying combined washing machine may include a hot air supply device for supplying high-temperature air into the drum and a condensing device for removing moisture from air discharged from the drum. For example, a drying combined washing machine may include a heat pump device. A washing machine according to various embodiments may include a washing machine using a washing method other than the above-described washing method.

A washing machine according to various embodiments may include a housing accommodating various components therein. The housing may be provided in the form of a box with a laundry inlet formed on one side thereof.

A washing machine may include a door for opening and closing the laundry inlet. The door may be rotatably mounted on the housing by hinges. At least a portion of the door may be transparent or translucent so that the inside of the housing is visible.

A washing machine may include a tub provided inside the housing to store water. The tub may be provided in a substantially cylindrical shape with a tub opening formed on one side thereof, and may be disposed inside the housing so that the tub opening is disposed to correspond to the laundry inlet.

The tub may be connected to the housing by a damper. The damper may absorb vibration that occurs when the drum rotates to attenuate the vibration to be transmitted to the housing.

A washing machine may include a drum provided to accommodate laundry.

The drum may be disposed inside the tub such that a drum opening provided on one side thereof corresponds to the laundry inlet and the tub opening. Laundry may sequentially pass through the laundry inlet, tub opening, and drum opening to be put into the drum or taken out from the drum.

The drum may perform each operation according to a washing, rinsing, and/or dewatering process while rotating inside the tub. A plurality of passing holes is formed on a cylindrical wall of the drum so that water stored in the tub may flow into or out of the drum.

A washing machine may include a driving device configured to rotate the drum. The driving device may include a driving motor and a rotating shaft for transmitting a driving force generated by the driving motor to the drum. The rotating shaft may penetrate the tub to be connected to the drum.

The driving device may rotate the drum forward or backward to perform each operation according to the washing, rinsing, and/or dewatering, or drying process.

A washing machine may include a water supply device configured to supply water to the tub. The water supply device may include a water supply pipe and a water supply valve provided in the water supply pipe. The water supply pipe may be connected to an external water supply source. The water supply pipe may extend from the external water supply source to a detergent supply device and/or the tub. Water may be supplied to the tub through the detergent supply device. Water may be supplied to the tub without passing through the detergent supply device.

The water supply valve may open or close the water supply pipe in response to an electrical signal from a controller. The water supply valve may allow or block water to be or from being supplied to the tub from the external water supply source. The water supply valve may include, for example, a solenoid valve that is opened and closed in response to the electrical signal.

A washing machine may include a detergent supply device configured to supply a detergent to the tub. The detergent supply device may include a manual detergent supply device configured such that a user supplies the detergent to be used each time washing, and an automatic detergent supply device configured to store a large amount of detergent and automatically supply a predetermined amount of detergent each time washing. The detergent supply device may include a detergent box for storing the detergent. The detergent supply device may be configured to supply the detergent into the tub in a water supply process. Water supplied through the water supply pipe may be mixed with the detergent by passing through the detergent supply device. The water mixed with the detergent may be supplied into the inside of the tub. The detergent may be used as a term encompassing a detergent for pre-washing, a detergent for main washing, a fabric softener, a bleaching agent, etc., and the detergent box may be divided into a detergent storage region for pre-washing, a detergent storage region for main washing, a fabric softener storage region, and a bleaching agent storage region.

A washing machine may include a drainage device configured to discharge water accommodated in the tub to the outside. The drainage device may include a drain pipe extending from a lower end of the tub to the outside of the housing, a drain valve provided on the drain pipe to open and close the drain pipe, and a pump provided on the drain pipe. The pump may pump water in the drain pipe to the outside of the housing.

A washing machine may include a control panel disposed on one surface of the housing. The control panel may provide a user interface for interaction between the user and the washing machine. The user interface may include at least one input interface and at least one output interface.

The at least one input interface may convert sensory information received from the user into an electrical signal.

The at least one input interface may include a power button, an operation button, a course selection dial (or course selection button), and washing/rinsing/dewatering setting buttons. The at least one input interface may include, for example, a tact switch, a push switch, a slide switch, a toggle switch, a micro switch, a touch switch, a touch pad, a touch screen, a jog dial, and/or a microphone, etc.

The at least one output interface may visually or auditorily deliver information related to operations of the washing machine to the user.

For example, the at least one output interface may deliver information related to a washing course, operating time of the washing machine, and washing setting/rinsing setting/dewatering setting to the user. The information about the operations of the washing machine may be output through a screen, an indicator, a voice, etc. The at least one output interface may include, for example, a liquid crystal display (LCD) panel, a light emitting diode (LED) panel, a speaker, etc.

A washing machine may include a communication module for wired and/or wireless communication with an external device.

The communication module may include at least one of a short-range communication module and a long-distance communication module.

The communication module may transmit data to or receive data from an external device (e.g., server, user device, and/or home appliance). For example, the communication module may establish communication with a server and/or a user device and/or a home appliance, and transmit and receive various data.

To this end, the communication module may support establishment of a direct (e.g., wired) communication channel or wireless communication channel between external devices, and performance of communication through the established communication channel. According to an embodiment, the communication module may include a wireless communication module (e.g., a cellular communication module, a short-range wireless communication module, or a global navigation satellite system (GNSS) communication module), or a wired communication module (e.g., a local area network (LAN) communication module, or a power line communication module). Among these communication modules, the corresponding communication module may communicate with an external device through the first network (e.g., a local area network such as Bluetooth, wireless fidelity (Wi-Fi) direct, or infrared data association (IrDA)) or the second network (e.g., a legacy cellular network, a 5G network, a next-generation communications network, the Internet, or a telecommunications network such as a computer network (e.g., LAN or WAN)). These various types of communication modules may be integrated into one component (e.g., a single chip) or may be implemented as a plurality of separate components (e.g., multiple chips).

The short-range wireless communication module may include, but is not limited thereto, a Bluetooth communication module, a Bluetooth low energy (BLE) communication module, a near field communication module, a WLAN (Wi-Fi) communication module, a ZigBee communication module, an infrared data association (IrDA) communication module, a Wi-Fi direct (WFD) communication module, an ultra-wideband (UWB) communication module, an Ant+communication module, microwave (U-wave) communication module, etc.

The long-distance communication module may include a communication module performing various types of long-distance communication and may include a mobile communication device. The mobile communication device transmits and receives wireless signals to and from at least one of a base station, an external terminal, and a server on a mobile communication network.

In an embodiment, the communication module may communicate with external devices such as a server, a user device, and another home appliance through a nearby access point (AP). The access point (AP) may connect the local area network (LAN) to which a washing machine or a user device is connected to a wide area network (WAN) to which a server is connected. The washing machine or the user device may be connected to the server via the wide area network (WAN). The controller may control various components of the washing machine (e.g., the driving motor and water supply valve). The controller may control various components of the washing machine to perform at least one process including water supply, washing, rinsing, and/or dewatering according to user input. For example, the controller may control the driving motor to regulate a rotational speed of the drum, or control the water supply valve of the water supply device to supply water to the tub.

The controller may include hardware such as a CPU or memory, and software such as a control program. For example, the controller may include an algorithm for controlling operations of components in a washing machine, at least one memory storing data in the form of a program, and at least one processor performing the operations using data stored in the at least one memory. The memory and processor may each be implemented as a separate chip. The processor may include one or two or more processor chips or one or two or more processing cores. The memory may include one or two or more memory chips or one or two or more memory blocks. The memory and processor may be implemented as a single chip.

Hereinafter, a clothes treating apparatus according to various embodiments will be described in detail with reference to the accompanying drawings. Hereinafter, a drying combined washing machine is described as an example of a clothes treating apparatus, but the present disclosure is not limited to a drying combined washing machine may be applied to various devices for treating and/or managing clothes.

The terms “front,” “rear,” “left,” and “right” used in the following description are defined based on the drawings, and the shape and location of each component are not limited by these terms.

For example, an X-axis direction may be defined as a front-rear direction, a Y-axis direction may be defined as a left-right direction, and a Z-axis direction may be defined as an up-down direction.

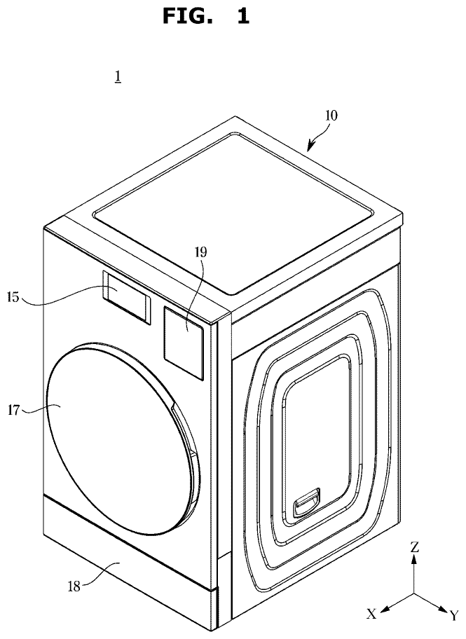

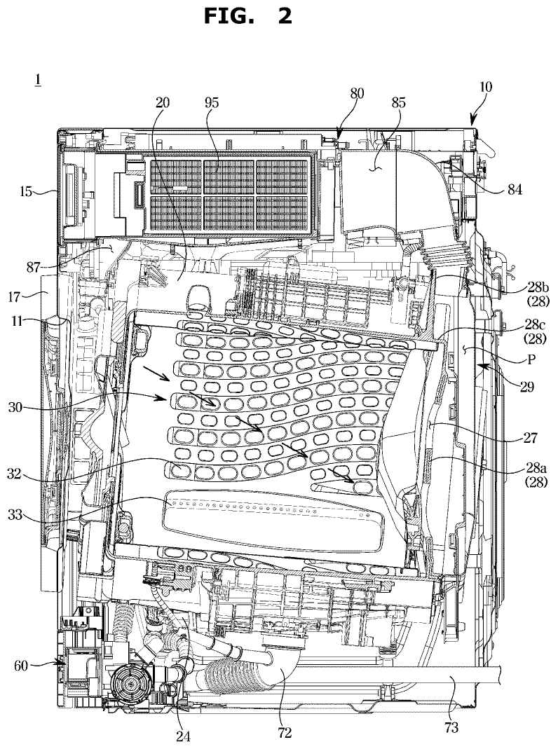

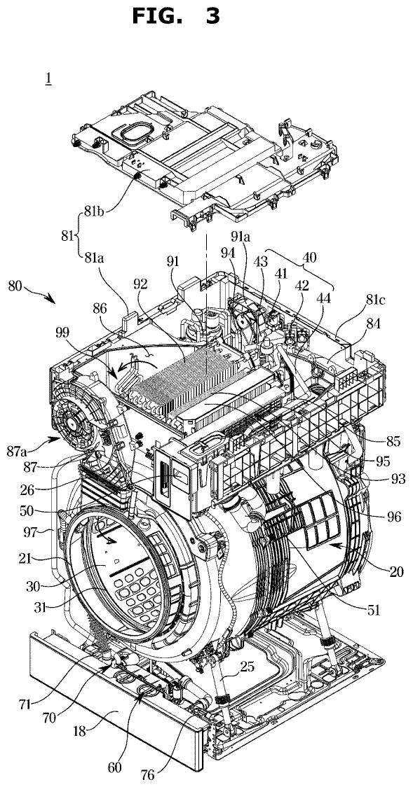

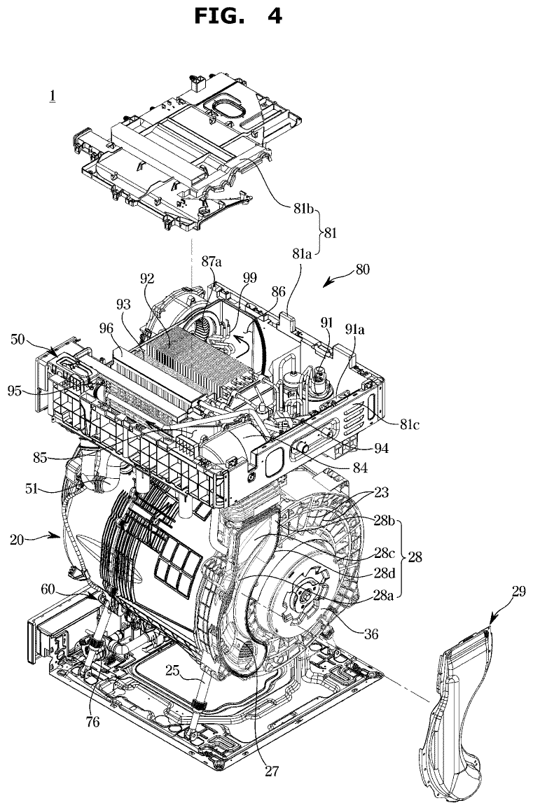

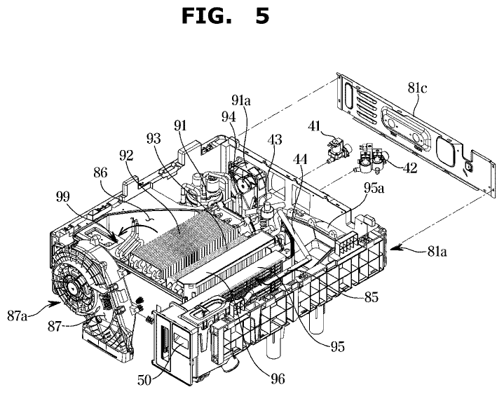

FIG. 1 illustrates a clothes treating apparatus according to an certain example embodiments. FIG. 2 illustrates a cross-section of the clothes treating apparatus according to an certain example embodiments. FIG. 3 illustrates some of components arranged inside the clothes treating apparatus according to an certain example embodiments. FIG. 4 illustrates the components arranged inside the clothes treating apparatus according to an certain example embodiments from a direction different from a direction illustrated in FIG. 3. FIG. 5 is an exploded view illustrating some components of a drying device according to an certain example embodiments.

Referring to FIGS. 1 to 5, a clothes treating apparatus 1 according to various embodiments may include a housing 10 provided to accommodate various components therein. The housing 10 may be provided in the form of a box with a laundry inlet 11 formed on one side thereof. The laundry inlet 11 may be provided to face substantially the front.

The clothes treating apparatus 1 may include a laundry door 17 provided to open and close the laundry inlet 11. The laundry door 17 may be rotatably mounted on, directly or indirectly, the housing 10 by hinges. At least a portion of the laundry door 17 may be provided to be transparent or translucent so that the inside of the housing 10 is visible. As an example, the laundry door 17 may include tempered glass.

The clothes treating apparatus 1 may include a lower door 18 configured to allow access to a lower detergent supply device 60. The clothes treating apparatus 1 may include an upper door 19 configured to allow access to an upper detergent supply device 50 and a filter 95.

The clothes treating apparatus 1 may include a tub 20 provided inside the housing 10 to store water. The tub 20 may be provided in a substantially cylindrical shape with a tub opening 21 formed on one side thereof, and may be disposed inside the housing 10 so that the tub opening 21 is disposed to correspond to the laundry inlet 11. The tub opening 21 may be provided to face substantially the front.

The tub 20 may be connected to the housing 10 by a damper 25. The damper 25 may absorb vibration occurring when a drum 30 rotates to attenuate the vibration to be transmitted to the housing 10.

The clothes treating apparatus 1 may include the drum 30 provided to accommodate laundry. At least one lifter 33 may be provided inside the drum 30 to perform washing by lifting and dropping laundry.

The drum 30 may be disposed inside the tub 20 such that a drum opening 31 provided on one side thereof corresponds to the laundry inlet 11 and the tub opening 21. Laundry may sequentially pass through the laundry inlet 11, the tub opening 21, and the drum opening 31 to be put into the drum 30 or taken out from the drum 30. The drum opening 31 may be provided to face substantially the front.

The drum 30 may perform each operation according to a washing, rinsing, and/or dewatering process while rotating inside the tub 20. A plurality of passing holes 32 is formed on a cylindrical wall of the drum 30 so that water stored in the tub 20 may flow into or out of the drum 30.

The clothes treating apparatus 1 may include a driving device 36 configured to rotate the drum 30. The driving device 36 may include a driving motor and a rotating shaft for transmitting a driving force generated by the driving motor to the drum 30. The rotating shaft may penetrate the tub 20 to be connected to the drum 30.

The driving device 36 may rotate the drum 30 forward or backward to perform each operation according to the washing, rinsing, and/or dewatering, or drying process.

The clothes treating apparatus 1 may include a water supply device 40 configured to supply water to the tub 20. The water supply device 40 may include water supply valves 41 and 42 provided to be connectable to an external water supply source. As an example, the water supply valves 41 and 42 may include the hot water supply valve 41 for supplying hot water and the cold water supply valve 42 for supplying cold water.

The water supply device 40 may include water supply pipes 43 and 44. The water supply pipes 43 and 44 may be connected to the water supply valves 41 and 42. As an example, the water supply pipes 43 and 44 may be provided as flexible hoses or pipes.

As an example, the water supply pipes 43 and 44 may include the hot water supply pipe 43 connected to the hot water supply valve 41, and the cold water supply pipe 44 connected to the cold water supply valve 42. At least one of the water supply pipes 43 and 44 may guide water from the water supply valves 41 and 42 to the tub 20. The at least one of the water supply pipes 43 and 44 may extend from the water supply valve 42 to the tub 20. Water may be supplied to the lower detergent supply device 60 through the tub 20. Water may also be supplied to the lower detergent supply device 60 without passing through the tub 20.

The water supply valves 41 and 42 may open or close the water supply pipes 43 and 44 in response to an electrical signal from a controller. The water supply valves 41 and 42 may allow or block the supply of water from the external water supply source to the tub 20. The water supply valves 41 and 42 may include, for example, solenoid valves provided to open or close in response to an electrical signal.

The clothes treating apparatus 1 may include the detergent supply devices 50 and 60 configured to supply a detergent to the tub 20. The detergent supply devices 50 and 60 may include the upper detergent supply device 50 and the lower detergent supply device 60. The detergent may be used as a term encompassing a detergent for pre-washing, a detergent for main washing, a fabric softener, a bleaching agent, etc.

The upper detergent supply device 50 may be positioned above the tub 20. The upper detergent supply device 50 may be positioned above the tub 20 in an up-down direction. The upper detergent supply device 50 may include a manual detergent supply device configured such that a user supplies a detergent to be used each time washing, or an automatic detergent supply device configured to store a large amount of detergent and automatically supply a predetermined amount of detergent each time washing. The upper detergent supply device 50 may be connected to the tub 20 through a detergent connection pipe 51. As an example, the upper detergent supply device 50 may be provided to supply a solid washing detergent and/or softener to the tub 20. However, the type of detergent is not limited to the above example.

The lower detergent supply device 60 may be positioned below the tub 20. The lower detergent supply device 60 may be positioned below the tub 20 in the up-down direction. The lower detergent supply device 60 may include a manual detergent supply device configured such that the user supplies a detergent to be used each time washing, or an automatic detergent supply device configured to store a large amount of detergent and automatically supply a predetermined amount of detergent each time washing. As an example, the lower detergent supply device 60 may be provided to supply a liquid washing detergent and/or softener to the tub 20. However, the type of detergent is not limited to the above example.

The clothes treating apparatus 1 may include a drainage device 70 configured to discharge water received in the tub 20 to the outside. The drainage device 70 may include a drainage pump 71 configured to discharge water in the tub 20 to the outside of the housing 10.

The clothes treating apparatus 1 may include a circulation pump 76 configured to circulate water in the tub 20 back to the tub 20 through the lower detergent supply device 60.

The drainage device 70 may be connected to the tub 20 through the tub connection pipe 72. The drainage device 70 may discharge water in the tub 20 to the outside of the housing 10 through a drain pipe 73.

The clothes treating apparatus 1 may include a control panel 15 disposed on one side surface of the housing 10. The control panel 15 may provide a user interface for interaction between the user and the clothes treating apparatus 1. The user interface may include at least one input interface and at least one output interface.

The at least one input interface may convert sensory information received from the user into an electrical signal.

The at least one input interface may include a power button, an operation button, a course selection dial (or course selection button), and washing/rinsing/dewatering setting buttons. The at least one input interface may include, for example, a tact switch, a push switch, a slide switch, a toggle switch, a micro switch, a touch switch, a touch pad, a touch screen, a jog dial, and/or a microphone, etc.

The at least one output interface may visually or auditorily deliver information related to operations of the clothes treating apparatus 1 to the user.

For example, the at least one output interface may deliver information related to a washing course, operating time of the clothes treating apparatus 1, and washing setting/rinsing setting/dewatering setting to the user. The information about the operations of the clothes treating apparatus 1 may be output through a screen, an indicator, a voice, etc. The at least one output interface may include, for example, a liquid crystal display (LCD) panel, a light emitting diode (LED) panel, a speaker, etc.

The clothes treating apparatus 1 may include a drying device 80 configured to dry laundry received inside the drum 30. The drying device 80 may be configured to heat air and supply the heated air to the inside of the tub 20. The drying device 80 may be configured to dry and heat air discharged from the tub 20 and circulate the dried and heated air to the inside of the tub 20 to dry clothes inside the drum 30. The drying device 80 according to various embodiments may be disposed above the tub 20.

The drying device 80 may include a drying case 81 in which a heat pump for drying air may be installed. The drying case 81 may include a drying base 81a and a drying cover 81b coupled to the drying base 81a to form a flow path through which air may move. The drying cover 81b may cover an open upper side of the drying base 81a.

Referring to FIG. 5, as an example, the drying device 80 may include a rear cover 81c provided to be coupled to a rear side of the drying base 81a. The rear cover 81c may form at least a portion of a rear surface of the drying device 80. The water supply valves 41 and 42 may be mounted on, directly or indirectly, the rear cover 81c.

The drying device 80 according to various embodiments may be provided as a heat pump type. The drying device 80 may include a compressor 91, a condenser 92, an evaporator 93, an expansion valve, and a refrigerant pipe 94 through which a refrigerant circulates. The compressor 91, the condenser 92, the evaporator 93, and the like, which constitute the heat pump, may be disposed in the drying case 81. For example, the drying device 80 may further include a cooling fan 91a provided to cool the compressor 91. As an example, the drying device 80 may be mounted as a single module.

The compressor 91 may compress the refrigerant, and the compressed high-temperature and pressure refrigerant may move to the condenser 92. The condenser 92 may cool the refrigerant to heat the surrounding air. The heated air may be introduced into the drum 30 to dry clothes.

The refrigerant expanded through the expansion valve may absorb heat from the evaporator 93 to cool the surrounding air. That is, the evaporator 93 may remove moisture by cooling high-temperature and humid air passed through the inside of the drum 30. The air from which moisture has been removed passes through the condenser 92 and exchanges heat with the refrigerant passing through the inside of the condenser 92, thereby being heated again. That is, the condenser 92 may heat air passed through the evaporator 93. The condenser 92 and the evaporator 93 may be referred to as heat exchangers.

As an example, the drying device 80 may further include a drying heater 99. The drying heater 99 may increase drying efficiency of the drying device 80. As an example, the heat pump components of the drying device 80 may be replaced with the drying heater 99.

The drying heater 99 may heat air introduced into the drying device 80. The drying heater 99 may be disposed on a heating flow path 86. The drying heater 99 may be disposed downstream of the condenser 92 along a flow of air passing through the drying device 80. In addition, the drying heater 99 may be provided in a relatively small size to minimize a flow path resistance. For example, the drying heater 99 may be a sheath heater.

The drying device 80 according to various embodiments may be disposed above the tub 20. An inlet flow path 85 may be formed in the drying device 80 to allow air discharged from the tub 20 to be introduced thereinto. A heating flow path 86 may be formed in the drying device 80 to allow air introduced into the drying device 80 through the inlet flow path 85 to exchange heat. A supply flow path 87 may be formed in the drying device 80 to allow air heat-exchanged while passing through the heating flow path 86 to be supplied to the tub 20.

The inlet flow path 85 may be provided to allow air passed through the inside of the tub 20 to be introduced into the drying device 80. The inlet flow path 85 may be positioned above the tub 20. The inlet flow path 85 may communicate with an exhaust flow path P formed at the rear of the tub 20.

The drying device 80 may include an inlet guide 84 connected to the tub 20. The inlet guide 84 may guide air discharged from the tub 20 to the inlet flow path 85. The inlet flow path 85 may communicate with the exhaust flow path P formed in the tub 20 through the inlet guide 84. The air passed through the exhaust flow path P may be introduced into the inlet flow path 85 of the drying device 80 through the inlet guide 84.

The filter 95 may be provided in the inlet flow path 85 to filter out foreign substances such as lint contained in the air introduced from the tub 20 through the exhaust flow path P. The air introduced into the inlet flow path 85 may pass through the filter 95 and then move to the heating flow path 86. The filter 95 may be positioned on a flow path through which air introduced into the drying device 80 moves to the evaporator 93 and the condenser 92.

The condenser 92 and the evaporator 93 may be disposed in the heating flow path 86. Because air introduced into the heating flow path 86 has passed through the inside of the tub 20, the air may be humid. The humid air may be cooled on the evaporator 93 disposed in the heating flow path 86 to remove moisture. The air from which moisture has been removed on the evaporator 93 may be heated again while passing through the condenser 92.

The drying device 80 may include a nozzle device 96 for washing the condenser 92 and/or the evaporator 93. The nozzle device 96 may be provided in the heating flow path 86. The nozzle device 96 may receive water from the water supply device 40 to inject washing water toward the condenser 92 and/or the evaporator 93.

The clothes treating apparatus 1 according to an certain example embodiments may include a drain line 97 provided to guide water discharged from the drying device 80. The drain line 97 may guide condensate generated on the heat exchangers of the drying device 80 to the outside of the drying device 80. The drain line 97 may guide the washing water injected by the nozzle device 96 to wash the heat exchangers to the outside of the drying device 80. The drain line 97 may be connected to the drainage device 70. The water discharged from the drying device 80 may flow to the drainage device 70 along the drain line 97. The water introduced into the drainage device 70 through the drain line 97 may be discharged to the outside of the clothes treating apparatus 1.

The supply flow path 87 may be provided to allow air heated while passing through the condenser 92 to be supplied back to the inside of the tub 20. The supply flow path 87 may communicate with the heating flow path 86 and extend downward to allow the heated air to be discharged toward the opening of the tub 20.

A supply fan 87a may be provided in the supply flow path 87 to flow air to the inside of the tub 20. That is, the supply fan 87a may be provided to supply air to laundry placed inside the drum 30. For example, the supply fan 87a may include a sirocco fan.

The inlet flow path 85, the heating flow path 86, and the supply flow path 87 may allow to circulate air to the inside of the tub 20 and the drying device 80.

The clothes treating apparatus 1 according to an certain example embodiments may be configured such that air discharged from the tub 20 sequentially passes through the inlet flow path 85, heating flow path 86, and supply flow path 87 of the drying device 80 positioned above the tub 20, and then is supplied to the inside of the tub 20.

Air heated in the drying device 80 may be supplied to the inside of the drum 30. In order to secure a region in which the heated air supplied into the inside of the drum 30 comes into contact with the laundry, a tub exhaust port 27 may be provided at a position opposite to an air inlet 26 through which the air heated in the drying device 80 is supplied to the tub 20. In order to allow more heated air to come into contact with laundry by increasing a distance and/or time that the heated air flows inside the drum 30, the tub exhaust port 27 may be provided at a position opposite to the air inlet 26 through which the air heated in the drying device 80 is supplied to the tub 20. The supply flow path 87 for supplying heated air to the inside of the drum 30 and the tub exhaust port 27 may be disposed to be spaced apart from each other. By increasing an area where heated air comes into contact with laundry, the drying efficiency may be improved.

The air inlet 26 and the tub exhaust port 27 according to an certain example embodiments may be disposed to maximize the use of the heated air provided from the drying device 80. As an example, the air inlet 26 may be positioned to be adjacent to a front surface of the tub 20, and the tub exhaust port 27 may be positioned to be adjacent to a rear surface of the tub 20.

The clothes treating apparatus 1 according to various embodiments may further include the exhaust flow path P for flowing air discharged from the inside of the tub 20 to the drying device 80. The exhaust flow path P may be provided to allow air discharged from the tub exhaust port 27 to flow to the inlet flow path 85 of the drying device 80. The exhaust flow path P may be provided to allow humid air passed through the tub 20 to be discharged. As an example, the exhaust flow path P may be provided at the rear of the tub 20.

Air in the tub 20 may be discharged into a tub duct 28 through the tub exhaust port 27 formed on the rear surface of the tub 20. The air discharged from the tub duct 28 may flow along the exhaust flow path P to be supplied to the drying device 80.

The clothes treating apparatus 1 according to various embodiments may include the tub duct 28 for forming at least a portion of the exhaust flow path P. As an example, the tub duct 28 may be formed integrally with the tub 20. As an example, the tub 20 may include the tub duct 28. The tub duct 28 may be provided to surround the tub exhaust port 27.

The clothes treating apparatus 1 according to various embodiments may include a duct cover 29 for forming at least a portion of the exhaust flow path P. The duct cover 29 may be provided to cover an open rear side of the tub duct 28. As an example, the tub 20 may include the duct cover 29. The duct cover 29 may form at least a portion of the exhaust flow path P through which air discharged through the tub exhaust port 27 flows to the drying device 80.

In the clothes treating apparatus 1 according to various embodiments, the exhaust flow path P may be formed by combining the duct cover 29 with the tub duct 28.

The tub duct 28 according to an embodiment may include a recess portion 28a forming one portion of the exhaust flow path P through which air discharged from the inside of the tub 20 flows. A reinforcing rib 23 may be provided on the rear surface of the tub 20 to reinforce the rigidity of the tub 20, and the recess portion 28a may be provided as a portion recessed from an end of the reinforcing rib 23 protruding from the rear surface of the tub 20. The recess portion 28a may be provided in a portion of the rear surface of the tub 20 where the reinforcing rib 23 is not formed. The tub exhaust port 27 may be formed at the recess portion 28a to allow air to be discharged from the inside of the tub 20. The tub duct 28 may include a partition rib 28d provided along a circumference of the recess portion 28a. The partition rib 28d may divide a region in which the reinforcing rib 23 is formed and a region in which the recess portion 28a is formed, on the rear surface of the tub 20.

The tub duct 28 according to an embodiment may include a duct connection portion 28b forming another portion of the exhaust flow path P through which air passed through the recess portion 28a flows. The duct connection portion 28b may protrude outward from an outer circumferential surface of the tub 20. The duct connection portion 28b may protrude substantially upward from the outer circumferential surface of the tub 20.

The duct connection portion 28b may communicate the drying device 80 and the recess portion 28a. The duct connection portion 28b may be connected to the inlet guide 84 of the drying device 80. The duct connection portion 28b may form a single passage forming the exhaust flow path P together with the recess portion 28a and the duct cover 29.

The duct connection portion 28b may be covered by the duct cover 29. The duct connection portion 28b may have an open side. The duct cover 29 may cover the open side of the duct connection portion 28b.

The duct cover 29 may cover both the recess portion 28a and the duct connection portion 28b. For example, the duct cover 29 may cover both an open side of the recess portion 28a and the open side of the duct connection portion 28b. The exhaust flow path P may be formed by the duct cover 29 covering the recess portion 28a and the duct connection portion 28b. As an example, the duct cover 29 may cover only the recess portion 28a.

The duct cover 29 may be provided to cover an open rear side of the recess portion 28a and/or an open rear side of the duct connection portion 28b. The exhaust flow path P may be a single passage formed together by the tub duct 28 and the duct cover 29.

The tub duct 28 may include a step portion 28c for expanding a cross-sectional area of the exhaust flow path P. The exhaust flow path P may be provided such that a width of a portion formed by the duct connection portion 28b is larger than a width of a portion formed in the recess portion 28a by the step portion 28c.

The arrangement positions of the water supply valves 41 and 42 of the clothes treating apparatus 1 according to an certain example embodiments may be determined by utilizing a space left by this mounting structure. In an certain example embodiments, the water supply valves 41 and 42 may be mounted between at least the inlet guide 84 and the cooling fan 91a. The water supply valves 41 and 42 may be positioned in a central portion of the rear surface of the drying device 80. The water valves 41 and 42 may be positioned at the rear of the condenser 92. The water supply valves 41 and 42 may be positioned in a region partitioned from a flow path through which the dry air flows. The positions of the water supply valves 41 and 42 are not limited to those exemplified.

The clothes treating apparatus 1 according to an certain example embodiments may include a washing water heater 24. The washing water heater 24 may be provided on a lower side of the tub 20 to heat washing water during washing. The water supply device 40 may supply a predetermined amount of water to the lower side of the tub 20 through the exhaust flow path P in the drying process, and the washing water heater 24 may heat water supplied to the inside of the tub 20 through the water supply device 40, the exhaust flow path P, and the tub exhaust port 27 to generate steam. That is, the steam generated by the water supply device 40 and the washing water heater 24 may come into contact with clothes in the drying process, thereby preventing wrinkles from forming on the clothes as much as possible.

That is, unlike a conventional dryer, the clothes treating apparatus 1 according to an certain example embodiments may include the washing water heater 24 for heating washing water as a washing/drying combined washing machine, and may generate steam by utilizing the washing water heater 24 and the water supply device 40 for washing of the exhaust flow path P to prevent wrinkles from forming on clothes in the drying process as much as possible.

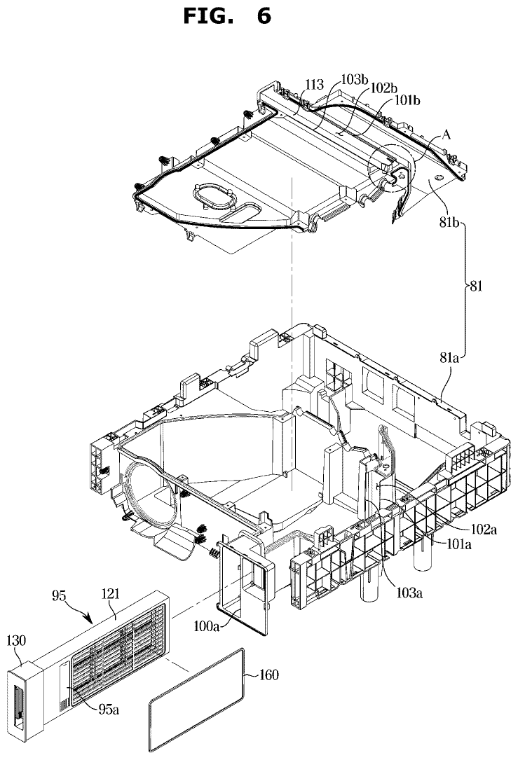

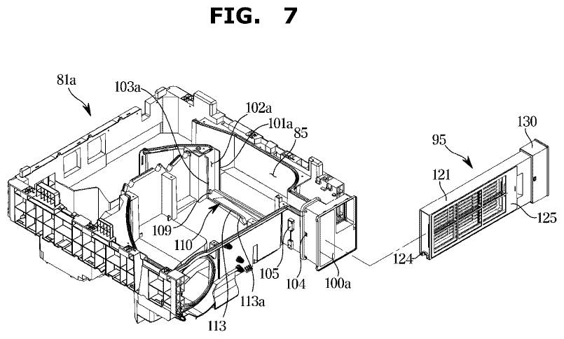

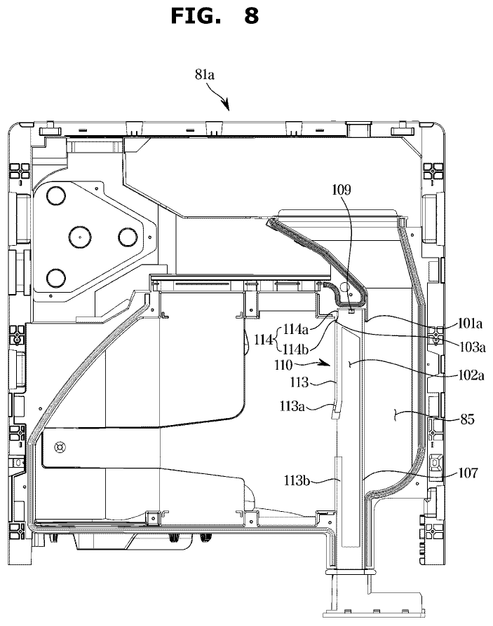

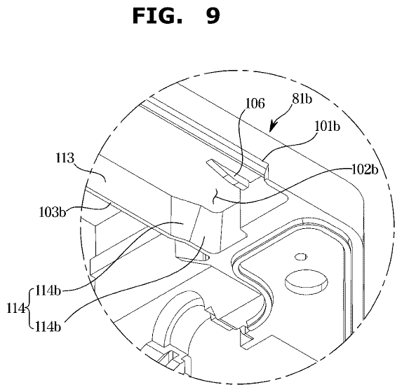

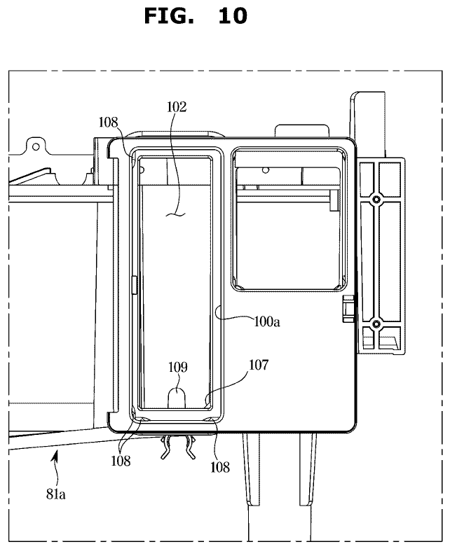

FIG. 6 is an exploded view illustrating some components of the drying device according to an certain example embodiments. FIG. 7 illustrates a drying base and a filter according to an certain example embodiments from a direction different from a direction illustrated in FIG. 6. FIG. 8 illustrates the drying base according to an certain example embodiments. FIG. 9 is an enlarged view of area A shown in FIG. 6. FIG. 10 illustrates a portion of the drying case according to an certain example embodiments.

Referring to FIGS. 6 to 8, the filter 95 may be detachably mounted on, directly or indirectly, the drying case 81. The filter 95 may include a filter cleaning member 95a configured to clean the filter 95. The filter cleaning member 95a may be detachably mounted on, directly or indirectly, a filter body 121.

The drying case 81 may include a filter mounting portion 102 to allow the filter 95 to be mounted therein. As an example, the filter mounting portion 102 may be formed by combining the drying base 81a and the drying cover 81b. The filter 95 may be accommodated in the filter mounting portion 102 of the drying case 81.

For example, the drying base 81a may include a base mounting portion 102a, and the drying cover 81b may include a cover mounting portion 102b. The base mounting portion 102a may include a portion having a groove shape. The cover mounting portion 102b may include a portion having a groove shape. As the drying base 81a and the drying cover 81b are combined, the base mounting portion 102a and the cover mounting portion 102b may form the filter mounting portion 102.

The drying case 81 may include a filter opening 100a provided to allow the filter 95 to be mounted therein. The filter opening 100a may be exposed to the outside when the upper door 19 is opened. The filter 95 may be inserted into the drying case 81 or withdrawn from the drying case 81 through the filter opening 100a. As an example, the filter opening 100a may be provided on the drying base 81a of the drying case 81.

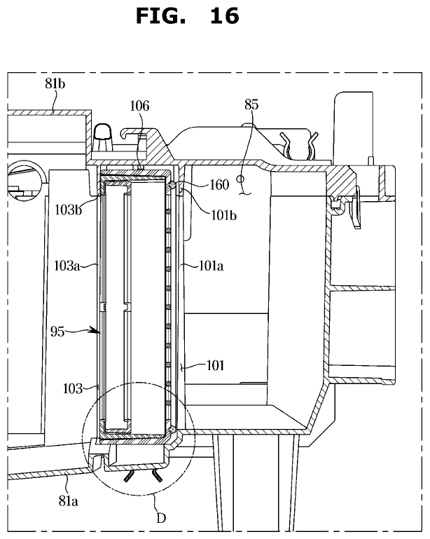

The drying case 81 may include a filter air inlet 101 (see FIG. 16). The filter air inlet 101 may be formed such that air introduced through the inlet flow path 85 may be introduced into the filter 95 located in the filter mounting portion 102. As an example, the filter air inlet 101 may be formed by combining the drying base 81a and the drying cover 81b.

For example, the drying base 81a may include a base inlet forming portion 101a, and the drying cover 81b may include a cover inlet forming portion 101b. The base inlet forming portion 101a may include a partition wall or rib. The cover inlet forming portion 101b may include a partition wall or rib. As the drying base 81a and the drying cover 81b are combined, the base inlet forming portion 101a and the cover inlet forming portion 101b may form the filter air inlet 101.

The clothes treating apparatus 1 according to various embodiments may include a sealing member 160 configured to prevent air introduced into the filter 95 through the filter air inlet 101 from leaking when the filter 95 is directly or indirectly mounted on the drying device 80. The sealing member 160 may be configured to seal between the filter 95 and the drying case 81 when the filter 95 is directly or indirectly mounted on the drying device 80. The sealing member 160 may be provided along an outer edge of the filter air inlet 101. The sealing member 160 may be configured to be in contact with a portion of the drying case 81 forming the filter air inlet 101.

The drying case 81 may include a filter air outlet 103 (see FIG. 16). The filter air outlet 103 may be formed such that air passed through the filter 95 may be discharged toward the evaporator 93 and the condenser 92. As an example, the filter air outlet 103 may be formed by combining the drying base 81a and the drying cover 81b.

For example, the drying base 81a may include a base outlet forming portion 103a, and the drying cover 81b may include a cover outlet forming portion 103b. The base outlet forming portion 103a may include a partition wall or rib. The cover outlet forming portion 103b may include a partition wall or rib. As the drying base 81a and the drying cover 81b are combined, the base outlet forming portion 103a and the cover outlet forming portion 103b may form the filter air outlet 103.

The drying case 81 may include a filter guide 110 configured to guide the filter 95 while the filter 95 is mounted on the filter mounting portion 102. The filter guide 110 may guide the sealing member 160 to be spaced apart from the drying case 81 while the filter 95 is mounted on the drying device 80, and may guide the sealing member 160 to be in close contact with the drying case 81 when the filter 95 is mounted on the drying device 80. As an example, the filter guide 110 may be provided on the drying base 81a and the drying cover 81b. Hereinafter, for convenience of explanation, the filter guide 110 provided on the drying base 81a will be described, and a component corresponding to the filter guide 110 provided on the drying base 81a may be provided on the drying cover 81b.

The filter guide 110 may include a filter rail 113 provided to guide the filter 95 so that the sealing member 160 may be spaced apart from the drying case 81 while the filter 95 is mounted on the drying device 80. The filter rail 113 may extend in a direction in which the filter 95 is mounted on the drying case 81. When one side of the filter 95 comes into contact with the filter rail 113, the other side of the filter 95 opposite to the one side may be spaced apart from the drying case 81.

The filter guide 110 may include a close-contact guide 114 provided to guide the filter 95 so that the sealing member 160 is in close contact with the drying case 81 when the filter 95 is mounted on the drying device 80. The close-contact guide 114 may be provided at a rear end of the filter rail 113. The close-contact guide 114 may guide a rear end of the filter 95.

The close-contact guide 114 may include a close-contact support portion 114a provided to support the filter 95 so that the sealing member 160 may be in close contact with the drying case 81, and a connection guide 114b provided to connect the filter rail 113 and the close-contact support portion 114a.

The close-contact support portion 114a may press the filter 95 in a direction in which the sealing member 160 comes into close contact with the drying case 81. The close-contact support portion 114a may extend in the direction in which the filter 95 is mounted on the drying case 81. The close-contact support portion 114a may be located closer to the filter air inlet 101 than to the filter rail 113. The close-contact support portion 114a may be provided to press the rear end of the filter 95 in the direction in which the sealing member 160 comes into close contact with the drying case 81 when the filter 95 is mounted on the drying device 80.

The connection guide 114b may extend in an inclined direction with respect to the up-down direction to connect the filter rail 113 and the close-contact support portion 114a. The connection guide 114b may extend from the filter rail 113 to the close-contact support portion 114a.

The filter rail 113 may guide the filter 95 to be mounted on the drying device 80 at a position closer to the filter air outlet 103 than to the filter air inlet 101. The close-contact guide 114 may guide the filter 95 to be mounted on the drying device 80 at a position closer to the filter air inlet 101 than to the filter air outlet 103. In other words, the filter 95 may be in close contact with the base inlet forming portion 101a and the cover inlet forming portion 101b forming the filter air inlet 101 by the close-contact guide 114.

The filter guide 110 may include a rail entry portion 113a provided to guide the filter 95 so that the filter 95 to be mounted on the drying device 80 may enter the filter rail 113. The rail entry portion 113a may extend from the filter rail 113 in a direction away from the filter air inlet 101. The filter rail 113 may be formed to extend from the base outlet forming portion 103a along the length direction of the filter 95, and the rail entry portion 113a may be formed to be inclined at a predetermined angle toward the outside of the filter guide 110. The filter 95 may move along an inclined surface to enter an inner side of the filter rail 113. The rail entry portion 113a may guide the filter 95 so that the filter 95 may enter the filter rail 113 by restricting the filter 95 from moving in a direction away from the filter air inlet 101 while the filter 95 is mounted on the drying device 80. The clothes treating apparatus 1 according to an certain example embodiments may prevent the filter 95 from being incorrectly mounted by the filter rail 113 and accommodate the filter 95 in the filter mounting portion 102.

A partial region of the filter rail 113 may be omitted along the direction in which the filter 95 is mounted. The filter rail 113 may include a spaced portion 113b spaced apart from a portion extending from the close-contact guide 114 and positioned close to the filter opening 100a. The spaced portion 113b of the filter rail 113 may be spaced apart from the rail entry portion 113a. A predetermined gap may be formed between the rail entry portion 113a and the spaced portion 113b of the filter rail 113. Defrosted water may move through the predetermined gap formed between the rail entry portion 113a and the separation portion 113b of the filter rail 113.

The drying case 81 may include a case coupling portion 109 provided to be coupled with a filter coupling portion 124 of the filter 95 when the filter 95 is mounted on the drying device 80. The case coupling portion 109 may be provided on the drying base 81a. The case coupling portion 109 may be provided at a rear end of the filter mounting portion 102. As an example, the case coupling portion 109 may have a protruding shape, and the filter coupling portion 124 may have a groove shape. Unlike this, the case coupling portion 109 may have a groove shape, and the filter coupling portion 124 may have a protruding shape. The case coupling portion 109 and the filter coupling portion 124 may be provided to interfere with the mounting of the filter 95 when the filter 95 is mounted on the drying device 80 with upper and lower sides thereof reversed. The case coupling portion 109 and the filter coupling portion 124 may guide the direction in which the filter 95 is mounted on the drying device 80. When the filter 95 is mounted on the drying device 80 with the upper and lower sides predetermined, the case coupling portion 109 and the filter coupling portion 124 may be combined. The user may check whether the filter 95 is normally mounted by the combination of the filter coupling portion 124 and the case coupling portion 109.

The filter 95 may be mounted by regions of the filter mounting portion 102 being divided by the base inlet forming portion 101a, the base outlet forming portion 103a, the filter rail 113, the cover inlet forming portion 101b, and the cover outlet forming portion 103b. A space in which the filter 95 may be mounted may be provided by the base inlet forming portion 101a, the base outlet forming portion 103a, the filter rail 113 which are formed on the drying base 81a, and the cover inlet forming portion 101b and the cover outlet forming portion 103b which are formed on the drying cover 81b. Although this embodiment illustrates the filter 95 as being in close contact from the filter air outlet 103 to the filter air inlet 101 in the moving direction, the filter 95 may also be in close contact from the filter air inlet 101 to the filter air outlet 103 in the moving direction.

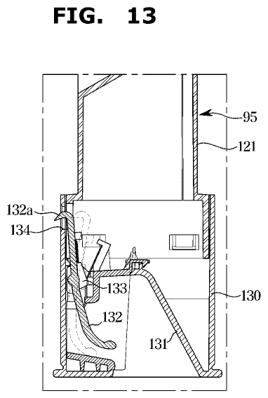

Referring to FIG. 7, the drying case 81 may include a filter fixing portion 104. The filter fixing portion 104 may be provided such that an end 132a (see FIG. 13) of a filter lever 132 (see FIG. 13) provided on the filter 95 is inserted when the filter 95 is mounted on the drying device 80. As the end 132a of the filter lever 132 is inserted into the filter fixing part 104, the filter 95 may be kept in a state of being mounted on the drying device 80.

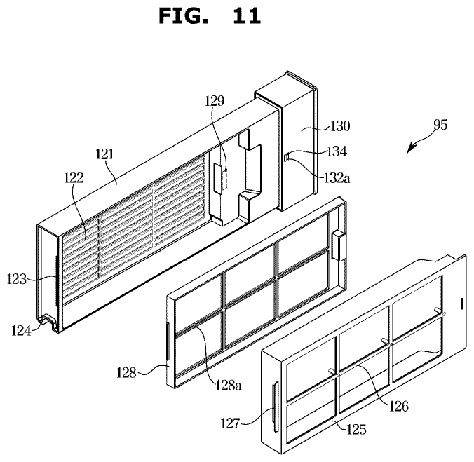

The drying device 80 may include a filter sensor 105. The filter sensor 105 may be provided to detect a magnetic material 129 (see FIG. 11) provided in the filter 95 when the filter 95 is mounted on the drying device 80. As the filter sensor 105 is provided to detect the magnetic material 129 provided in the filter 95, the user may check that the filter 95 is fully mounted onto the drying device 80.

Referring to FIG. 9, the drying case 81 may include a case fixing portion 106 provided to fix the filter 95 when the filter 95 is mounted on the drying device 80. The case fixing portion 106 may be provided to press the rear end of the filter 95 when the filter 95 is mounted on the drying device 80. As an example, the case fixing portion 106 may be provided on the drying cover 81b. The case fixing portion 106 may protrude downward from an upper surface of the filter mounting portion 102. The case fixing portion 106 may be provided to press the filter 95 in a direction perpendicular to a direction in which the close-contact guide 114 presses the filter 95 when the filter 95 is mounted on the drying device 80. As an example, the case fixing portion 106 may be provided in multiple pieces. As an example, the case fixing portion 106 may be formed in a protruding shape on an upper surface of the filter 95.

Referring to FIG. 10, the drying case 81 may include a guide edge 107 for guiding the direction in which the filter 95 is mounted on the drying device 80. As an example, the guide edge 107 may be formed at a lower portion of the filter mounting portion 102. The guide edge 107 may be one of a plurality of edges forming the filter mounting portion 102. The guide edge 107 may have a different shape from the other edges forming the filter mounting portion 102. As the guide edge 107 among the plurality of edges forming the filter mounting portion 102 has a different shape from the other edges, a cross-section of the filter mounting portion 102 perpendicular to the direction in which the filter 95 is mounted on the drying device 80 may be provided with an asymmetrical shape. The filter mounting portion 102 of the drying case 81 may be provided with the guide edge 107 in which one of the four edges is different from the other edges in the cross-section perpendicular to the direction in which the filter 95 is mounted on the drying device 80.

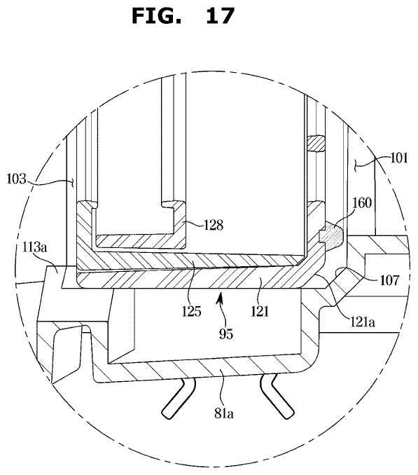

The filter 95 may include a filter edge 121a (see FIG. 17) corresponding to the guide edge 107. The guide edge 107 may be provided to interfere with the filter 95 when the filter 95 is mounted on the dryer device 80 in an incorrect direction.

The drying case 81 may include a case support portion 108 provided to press the filter 95 in the direction in which the sealing member 160 comes into close contact with the drying case 81 when the filter 95 is mounted on the drying device 80. The case support portion 108 may be provided at a position adjacent to the filter opening 100a. The case support portion 108 may be provided to support a front end of the filter 95. As an example, the case support portion 108 may be provided to press at least one corner portion of the front end of the filter 95.

When the filter 95 is mounted on the drying device 80, the rear end of the filter 95 is pressed by the close-contact guide 114 and the front end of the filter 95 is pressed by the case support portion 108, so that the sealing member 160 may be in close contact with the drying case 81.

Because the clothes treating apparatus 1 according to various embodiments is configured such that the sealing member 160 may be spaced apart from the drying case 81 by the filter rail 113 while the filter 95 is mounted on the drying device 80, and the sealing member 160 may be in close contact with the drying case 81 by the close-contact guide 114 and/or the case support portion 108 when the filter 95 is mounted on the drying device 80, a force required to overcome friction between the sealing member 160 and the drying case 81 while the filter 95 is mounted on the drying device 80 may be reduced. The clothes treating apparatus 1 may be configured such that the filter 95 may be easily mounted on and separated from the drying apparatus 80.

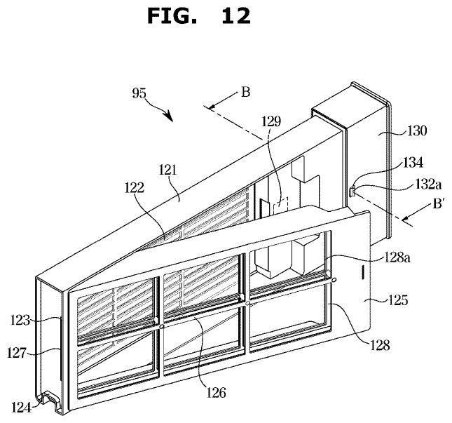

FIG. 11 is an exploded view of the filter according to an certain example embodiments. FIG. 12 illustrates a state in which a filter cover is mounted on a filter body according to an certain example embodiments. FIG. 13 illustrates a cross-section cut along line B-B′ shown in FIG. 12.

Referring to FIGS. 11 to 13, the filter 95 according to various embodiments may include the filter body 121 and a filter cover 125.

The filter body 121 may include a body filter portion 122 provided to allow air passed through the filter air inlet 101 of the drying case 81 to be introduced into the inside of the filter body 121. While air passed through the filter air inlet 101 passes through the body filter portion 122, foreign substances may be filtered out. The body filter portion 122 may be provided to face the filter air inlet 101.

The filter body 121 may include a filter coupling portion 124 provided to be coupled with the case coupling portion 109 of the drying case 81 when mounted on the drying device 80.

The filter body 121 may include a body coupling portion 123 provided to be coupled with the filter cover 125. The body coupling portion 123 may be coupled with a cover coupling portion 127 provided on the filter cover 125. As an example, the body coupling portion 123 may have a slit shape, and the cover coupling portion 127 may have a protruding shape of being inserted into the body coupling portion 123. Unlike this, the body coupling portion 123 may have a protruding shape, and the cover coupling portion 127 may have a slit shape.

The filter body 121 may include the magnetic material 129 provided to fix the filter cover 125 when combined with the filter cover 125. The magnetic material 129 may be positioned on one side of the filter body 121 opposite to a side where the body coupling portion 123 is positioned. The filter cover 125 may include a portion that may be fixed to the magnetic material 129 provided on the filter body 121 by a magnetic force.

Referring to FIG. 12, in a state in which the cover coupling portion 127 is primarily coupled to the body coupling portion 123, the filter cover 125 may be mounted on the filter body 121 by fixing a side opposite to one side where the cover coupling portion 127 is positioned by the magnetic material 129 and the magnetic force.

The filter 95 may include an internal filter 128 provided inside the filter body 121. The internal filter 128 may include an internal filter portion 128a for filtering out foreign substances from air passing through the internal filter 128. The internal filter part 128a may filter out foreign substances from air passing through the body filter 122 of the filter body 121. The internal filter 128 may be mounted on the filter body 121 or the filter cover 125.

The filter cover 125 may include the cover coupling portion 127 provided to be coupled to the body coupling portion 123. The filter cover 125 may include a cover filter portion 126 provided to filter out foreign substances from air being discharged from the filter 95. The cover filter portion 126 may filter out foreign substances from air passing through the internal filter portion 128a.

The filter 95 may include a handle 130. As the upper door 19 is opened in a state in which the filter 95 is mounted on the drying device 80, the handle 130 may be exposed to the outside of the clothes treating apparatus 1. The handle 130 may be provided at a front end of the filter 95.

Referring to FIG. 13, the filter 95 may include a filter lever 132 provided to fix the filter 95 to the drying device 80 when the filter 95 is mounted on the drying device 80. The filter lever 132 may be rotatably mounted on the handle 130. The filter lever 132 may be provided to be rotatable between a first position in which the end 132a of the filter lever 132 is inserted into the filter fixing portion 104 and a second position in which the end 132a is deviated from the filter fixing portion 104.

The filter 95 may include a lever elastic body 133 provided to elastically support the filter lever 132. The lever elastic body 133 may provide elasticity to the filter lever 132 in a direction in which the end 132a of the filter lever 132 is inserted into a lever hole 134 formed on the handle 130. As an example, the lever elastic body 133 may include a leaf spring.

The handle 130 may include a handle groove 131 formed to allow access to the filter lever 132. The user may put a hand thereof into the handle groove 131 and manipulate the lever 132.

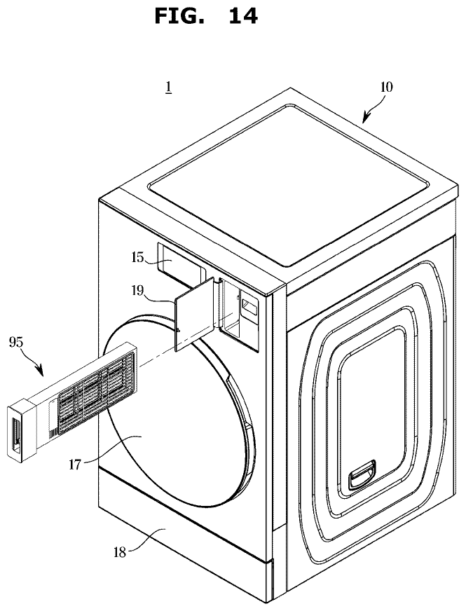

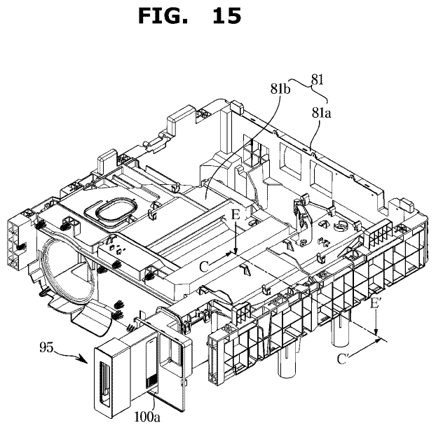

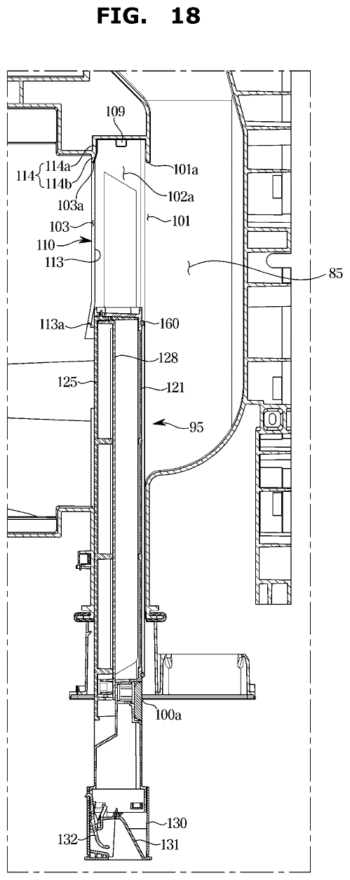

FIG. 14 illustrates a state in which the filter according to an certain example embodiments is separated from the clothes treating apparatus. FIG. 15 illustrates a state in which the filter according to an certain example embodiments is inserted into the drying case to a first position. FIG. 16 illustrates a cross-section cut along line C-C′ shown in FIG. 15. FIG. 17 is an enlarged view of area D shown in FIG. 16. FIG. 18 illustrates a cross-section cut along line E-E′ shown in FIG. 15.

Referring to FIG. 14, the clothes treating apparatus 1 according to various embodiments may open the upper door 19 to mount the filter 95 on the drying device 80. Referring to FIG. 15, the filter 95 may be inserted into the drying case 81 to the first position.

Referring to FIGS. 16 and 17, when the filter 95 is inserted into the drying case 81 to the first position, the sealing member 160 may not come into contact with the drying case 81. When the filter 95 is inserted into the drying case 81 to the first position, the sealing member 160 may be spaced apart from the drying case 81. When the filter 95 is inserted into the drying case 81 to the first position, the sealing member 160 may form a gap together with the drying case 81. While the filter 95 is inserted to the first position, the sealing member 160 may not interfere with the drying case 81.

The filter 95 may include the filter edge 121a. The filter edge 121a may be formed to correspond to a guide edge 107 formed in the drying case 81. The filter edge 121a may extend in the direction in which the filter 95 is mounted on the drying device 80. The filter edge 121a may have a different shape from other edges of the filter 95. By means of the filter edge 121a, the filter 95 may be provided with an asymmetrical shape in a cross-section perpendicular to the direction in which the filter 95 is mounted on the drying device 80. The filter 95 may be provided with the filter edge 121a in which one of the four edges is different from the other edges in the cross-section perpendicular to the direction in which the filter 95 is mounted on the drying device 80.

Referring to FIG. 18, when the filter 95 is inserted into the drying case 81 to the first position, the rear end of the filter 95 may be guided to the filter rail 113 by the rail entry portion 113a. According to this configuration, the clothes treating apparatus 1 according to an embodiment may prevent the filter 95 from being mounted on an incorrect direction.

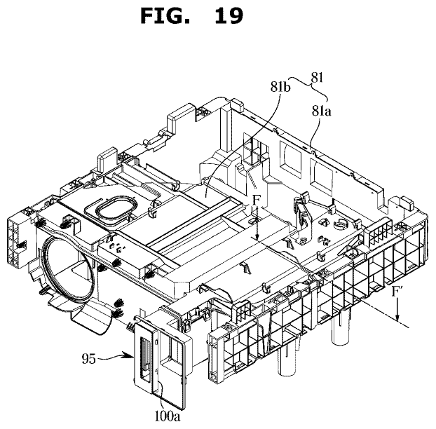

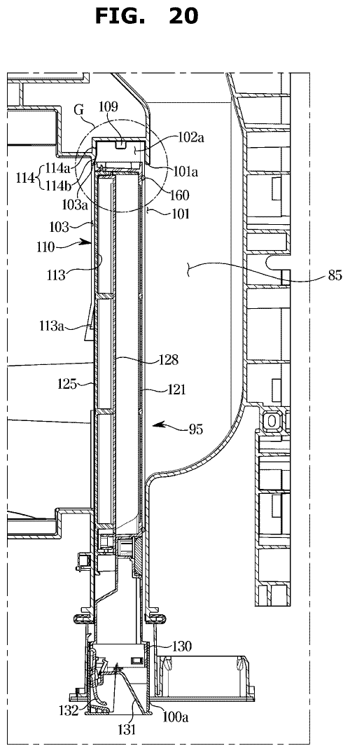

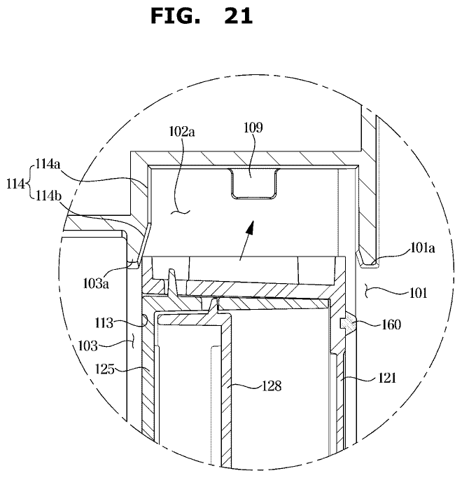

FIG. 19 illustrates a state in which the filter according to an certain example embodiments is inserted into the drying case to a second position. FIG. 20 illustrates a cross-section cut along line F-F′ shown in FIG. 19. FIG. 21 is an enlarged view of area G shown in FIG. 20.

Referring to FIGS. 19 to 21, the filter 95 may be inserted into the drying case 81 to the second position.

The filter 95 may be guided by the filter rail 113 and inserted from the first position to the second position. While the filter 95 is inserted from the first position to the second position, the sealing member 160 may not come into contact with the drying case 81. While the filter 95 is inserted from the first position to the second position, the sealing member 160 may be spaced apart from the drying case 81. While the filter 95 is inserted from the first position to the second position, the sealing member 160 may form a gap together with the drying case 81. While the filter 95 is inserted from the first position to the second position, the sealing member 160 may not interfere with the drying case 81.

When the filter 95 is inserted into the drying case 81 to the second position, the rear end of the filter 95 may be guided by the connection guide 114b of the close-contact guide 114. The filter 95 may be guided from the second position by the close-contact guide 114 in the direction in which the sealing member 160 comes into close contact with the drying case 81.

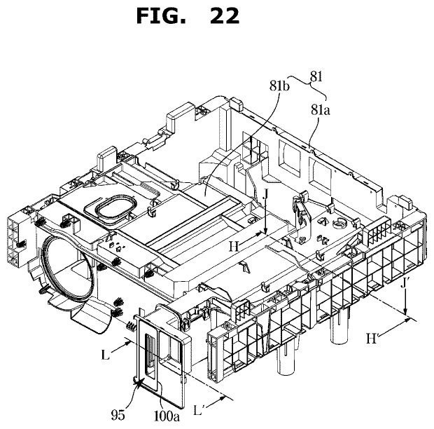

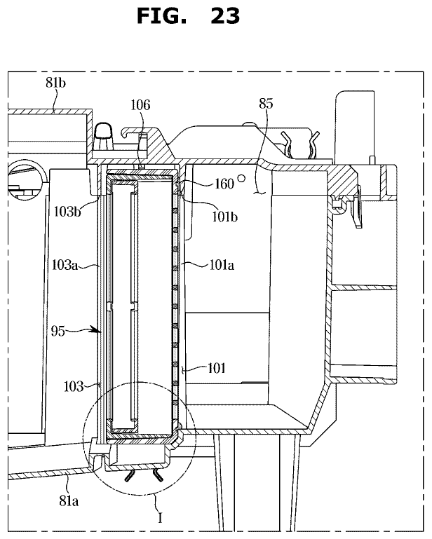

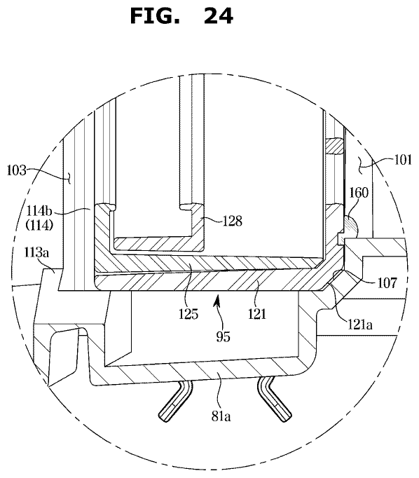

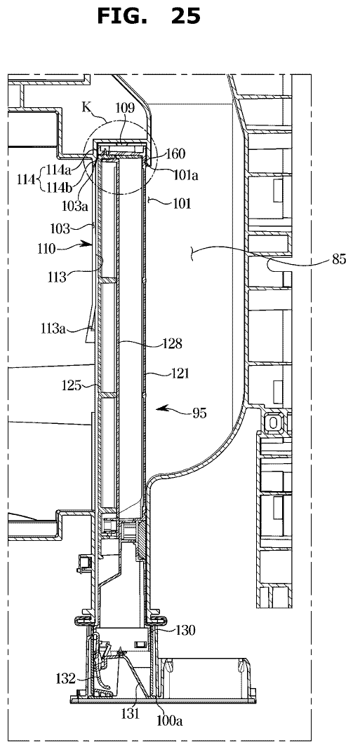

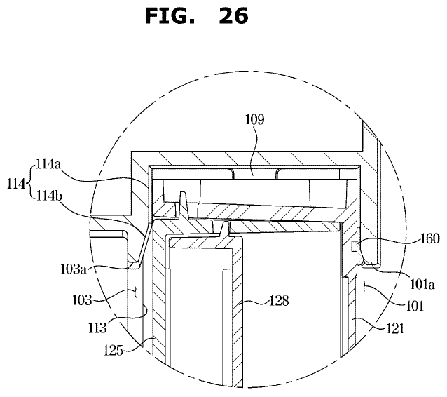

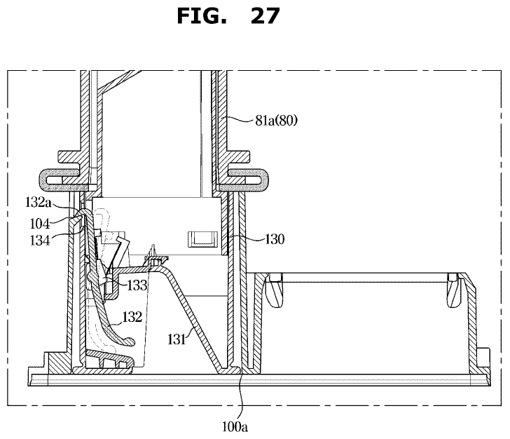

FIG. 22 illustrates a state in which the filter according to an certain example embodiments is inserted into the drying case to a third position. FIG. 23 illustrates a cross-section cut along line H-H′ shown in FIG. 22. FIG. 24 is a n enlarged view of area I shown in FIG. 23. FIG. 25 illustrates a cross-section cut along line J-J′ shown in FIG. 22. FIG. 26 is an enlarged view of area K shown in FIG. 25. FIG. 27 illustrates a cross-section cut along line L-L′ shown in FIG. 22.

Referring to FIG. 22, the filter 95 may be inserted into the drying case 81 to a third position. When the filter 95 is inserted into the drying case 81 to the third position, the filter 95 may be fully mounted onto the drying device 80.

Referring to FIGS. 23 to 26, the filter 95 may be guided to the close-contact support portion 114a of the close-contact guide 114 by the connection guide 114b of the close-contact guide 114. As the filter 95 is inserted from the second position to the third position, the sealing member 160 may come into close contact with the drying case 81. As the filter 95 is inserted from the second position to the third position, the sealing member 160 may interfere with the drying case 81. As the filter 95 moves to the third position, the filter 95 may be supported by the close-contact support portion 114a of the close-contact guide 114. As the filter 95 is pressed by the close-contact support portion 114a, the sealing member 160 may be deformed between the filter 95 and the drying case 81 and seal an edge of the filter air inlet 101.

Referring to FIG. 27, the end 132a of the filter lever 132 provided in the filter 95 may be inserted into the filter fixing portion 104 formed in the drying case 81. As the end 132a of the filter lever 132 is inserted into the filter fixing portion 104, the filter 95 may be fixed to the drying case 81 so as not to be separated from the drying case 81.

A clothes treating apparatus 1 according to an embodiment may include a tub 20, a drying device 80 configured to supply dry air to the tub and including a drying case 81 on which an evaporator 93 and a condenser 92 are mounted, a filter 95 configured to be detachably mountable on the drying device, and a sealing member 160, comprising sealing material, configured to seal between at least the filter and the drying case when the filter is mounted on the drying device. The drying case may include a filter rail 113 configured to guide the filter so that the sealing member is spaced apart from the drying case while the filter is mounted on the drying device, and a close-contact guide 114 configured to guide the filter so that the sealing member comes into close contact with the drying case when the filter is mounted on the drying device.

The close-contact guide may include a close-contact support portion 114a configured to support the filter in a direction in which the sealing member comes into close contact with the drying case, and a connection guide 114b extending between the filter rail and the filter support portion.

The close-contact support portion may be configured to press a rear end of the filter in the direction in which the sealing member comes into close contact with the drying case when the filter is mounted on the drying device. The drying case may include a case support portion 108 configured to press a front end of the filter in the direction in which the sealing member comes into close contact with the drying case when the filter is mounted on the drying device.

The drying case may include a case fixing portion 106 configured to press the filter in a direction substantially perpendicular to a direction in which the close-contact guide presses the filter when the filter is mounted on the drying device.

The drying case may include a rail entry portion 113a configured to guide the filter to the filter rail while the filter is mounted on the drying device.

The drying case may include a filter air inlet 101 configured so that air discharged from the tub is introduced into the filter when the filter is mounted on the drying device. The sealing member may be disposed at least along at least part of an edge of the filter air inlet on the outside of the edge of the filter air inlet.

The drying case may include a filter air outlet 103 through which air passed through the filter is discharged toward the evaporator and the condenser. The filter rail may be configured to guide the filter to be mounted on the drying device at a position closer to the filter air outlet than to the filter air inlet. The close-contact guide may be configured to guide the filter to be mounted on the drying device at a position closer to the filter air inlet than to the filter air outlet.

The filter may include a filter body 121, an internal filter 128 accommodated at least partially inside of the filter body, and a filter cover 125 detachably mounted on the filter body.

The filter body may include a magnetic material 129. The filter cover may be configured to be mountable on the filter body by magnetic force with the magnetic material.

The filter body may include a body coupling portion 123. The filter cover may include a cover coupling portion 127 configured to be couplable to the body coupling portion, and may be configured to be mountable on the filter body by magnetic force with the magnetic material when the cover coupling portion is coupled to the body coupling portion.

The drying device may include a filter sensor 105 configured to detect the magnetic material when the filter is mounted on the drying device.

The drying case may include a filter fixing portion 104. The filter may include a handle 130, and a filter lever 132 rotatably coupled to the handle, the filter lever configured to be rotatable between a first position of being inserted into the filter fixing portion and a second position of being deviated from the filter fixing portion.

The filter may include a filter edge 121a having a different shape from other edges among a plurality of the edges so that a cross-section perpendicular to a direction in which the filter is mounted on the drying device has an asymmetrical shape. The drying case may include a guide edge 107 having a different shape from other edges among a plurality of the edges to have a shape corresponding to the asymmetric shape of the filter.

The drying case may include a case coupling portion 109. The filter may include a filter coupling portion 124 configured to be coupled to the case coupling portion when the filter is mounted on the drying device.

The filter may be positioned on a flow path through which air introduced into the drying device moves to the evaporator and the condenser.

A clothes treating apparatus 1 according to an embodiment may include a tub 20, a drying device 80 configured to supply dry air to the tub and including a drying case 81 on which an evaporator 93 and a condenser 92 are mounted, a filter 95 detachably mountable on the drying device, and a sealing member 160 configured to seal between the filter and the drying case when the filter is mounted on the drying device. The drying case may include a filter rail 113 provided to guide the filter so that the sealing member is spaced apart from the drying case while the filter is mounted on the drying device, a close-contact guide 114 provided to press a rear end of the filter so that the sealing member comes into close contact with the drying case when the filter is mounted on the drying device, and a case support portion 108 provided to press a front end of the filter so that the sealing member comes into close contact with the drying case when the filter is mounted on the drying device.

The drying case may include a rail entry portion 113a provided to guide the filter to the filter rail while the filter is mounted on the drying device.

The drying case may include a filter air inlet 101 formed such that air discharged from the tub is introduced into the filter when the filter is mounted on the drying device. The sealing member may be disposed along an edge of the filter air inlet on the outside of the edge of the filter air inlet.

The filter may include a magnetic material. The drying device may include a filter sensor 105 provided to detect the magnetic material when the filter is mounted on the drying device.

The drying case may include a filter fixing portion 104. The filter may include a handle 130, and a filter lever 132 rotatably coupled to the handle and provided to be rotatable between a first position of being inserted into the filter fixing portion and a second position of being deviated from the filter fixing portion.

According to a clothes treating apparatus of the present disclosure, because a filter is guided by a filter rail so that a sealing member is spaced apart from a drying case while the filter is mounted on a drying device, damage to the sealing member can be reduced.

According to the clothes treating apparatus of the present disclosure, because the filter is guided by the filter rail so that the sealing member is spaced apart from the drying case while the filter is mounted on the drying device, the magnitude of a force required to be applied to the filter is reduced, so that the filter can be easily mounted.

According to the clothes treating apparatus of the present disclosure, because the filter is pressed by a close-contact guide and a case support portion so that the sealing member comes into close contact with the drying case when the filter is mounted on the drying device, leakage of air introduced into the filter can be reduced.

According to the clothes treating apparatus of the present disclosure, because a filter lever is provided to fix the filter to the drying device when the filter is mounted directly or indirectly on the drying device, the filter can be stably fixed to the drying device.

According to the clothes treating apparatus of the present disclosure, because the filter is provided with an internal filter and filter cover capable of filtering out foreign substances, the performance of the filter can be improved.

Effects obtainable from the present disclosure are not limited to the effects mentioned above, and other effects not mentioned will be clearly understood by those skilled in the art to which the present disclosure belongs from the fallowing description.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A clothes treating apparatus comprising:
a tub;
a drying device configured to supply dry air to the tub and comprising a drying case on which an evaporator and a condenser are mounted;
a filter configured to be detachably mountable on the drying device; and
a sealing member, comprising sealing material, configured to seal between at least the filter and the drying case when the filter is mounted on the drying device,
wherein the drying case comprises:
a filter rail configured to guide the filter so that the sealing member is spaced apart from the drying case while the filter is mounted on the drying device; and
a close-contact guide configured to guide the filter so that the sealing member comes into close contact with the drying case when the filter is mounted on the drying device.

2. The clothes treating apparatus according to claim 1, wherein
the close-contact guide comprises:
a close-contact support portion configured to support the filter in a direction in which the sealing member comes into close contact with the drying case; and
a connection guide extending between the filter rail and the filter support portion.

3. The clothes treating apparatus according to claim 2, wherein
the close-contact support portion is configured to press a rear end of the filter in the direction in which the sealing member comes into close contact with the drying case when the filter is mounted on the drying device, and
the drying case comprises a case support portion configured to press a front end of the filter in the direction in which the sealing member comes into close contact with the drying case when the filter is mounted on the drying device.

4. The clothes treating apparatus according to claim 3, wherein
the drying case comprises a case fixing portion configured to press the filter in a direction substantially perpendicular to a direction in which the close-contact guide presses the filter when the filter is mounted on the drying device.

5. The clothes treating apparatus according to claim 1, wherein
the drying case comprises a rail entry portion configured to guide the filter to the filter rail while the filter is mounted on the drying device.

6. The clothes treating apparatus according to claim 1, wherein
the drying case comprises a filter air inlet configured so that air discharged from the tub is introduced into the filter when the filter is mounted on the drying device, and
the sealing member is disposed at least along at least part of an edge of the filter air inlet on the outside of the edge of the filter air inlet.

7. The clothes treating apparatus according to claim 6, wherein
the drying case comprises a filter air outlet through which air passed through the filter is discharged toward the evaporator and the condenser,
the filter rail is configured to guide the filter to be mounted on the drying device at a position closer to the filter air outlet than to the filter air inlet, and
the close-contact guide is configured to guide the filter to be mounted on the drying device at a position closer to the filter air inlet than to the filter air outlet.

8. The clothes treating apparatus according to claim 1, wherein
the filter comprises:
a filter body;
an internal filter accommodated at least partially inside of the filter body; and
a filter cover detachably mounted on the filter body.

9. The clothes treating apparatus according to claim 8, wherein
the filter body comprises a magnetic material, and
the filter cover is configured to be mountable on the filter body by magnetic force with the magnetic material.

10. The clothes treating apparatus according to claim 9, wherein
the filter body comprises a body coupling portion, and
the filter cover comprises a cover coupling portion configured to be couplable to the body coupling portion, and is configured to be mountable on the filter body by magnetic force with the magnetic material when the cover coupling portion is coupled to the body coupling portion.

11. The clothes treating apparatus according to claim 9, wherein
the drying device comprises a filter sensor configured to detect the magnetic material when the filter is mounted on the drying device.

12. The clothes treating apparatus according to claim 1, wherein
the drying case comprises a filter fixing portion, and
the filter comprises:
a handle; and
a filter lever rotatably coupled to the handle, the filter lever configured to be rotatable between a first position of being inserted into the filter fixing portion and a second position of being deviated from the filter fixing portion.

13. The clothes treating apparatus according to claim 1, wherein
the filter comprises a filter edge having a different shape from other edges among a plurality of the edges so that a cross-section perpendicular to a direction in which the filter is mounted on the drying device has an asymmetrical shape, and
the drying case comprises a guide edge having a different shape from other edges among a plurality of the edges to have a shape corresponding to the asymmetric shape of the filter.

14. The clothes treating apparatus according to claim 1, wherein
the drying case comprises a case coupling portion, and
the filter comprises a filter coupling portion configured to be coupled to the case coupling portion when the filter is mounted on the drying device.

15. The clothes treating apparatus according to claim 1, wherein
the filter is positioned on a flow path through which air introduced into the drying device moves to the evaporator and the condenser.
